(19) United States
(12) Patent Application Publication
(10) Pub. No.: US 2025/0317032 A1
(43) Pub. Date: Oct. 9, 2025

(54) SENSOR DEVICE FOR DETERMINING A POSITION OF A STRUCTURAL COMPONENT OF A VEHICLE COMPONENT, CONTROL ARRANGEMENT, VEHICLE COMPONENT, MOTOR VEHICLE AND METHOD

(71) Applicant: AUDI AG, Ingolstadt (DE)

(72) Inventor: Benjamin KONRAD, Hallbergmoos (DE)

(21) Appl. No.: 19/097,635

(22) Filed: Apr. 1, 2025

(30) Foreign Application Priority Data
Apr. 3, 2024 (DE) 102024109336.6

(51) Int. Cl. H02K 11/215; H02K 7/00; H02P 27/06

(52) U.S. Cl. CPC H02K 11/215; H02K 7/006; H02P 27/06; H02K 2211/03

(57) ABSTRACT

A sensor device for determining a position of a rotatably and/or longitudinally displaceably mounted structural component of a vehicle component for a motor vehicle, comprising at least one processing circuit which is set up to generate at least one electrical and position-dependent sensor signal with a sensor signal voltage and to output it via at least one signal output, wherein the at least one processing circuit is further set up to check whether an error state relating to the sensor device is present in which the generation of the at least one sensor signal is prevented, and, in this case, to generate at least one error signal with an error signal voltage that deviates from the at least one sensor signal voltage and to output it via the at least one signal output.

### BACKGROUND

### Technical Field

The present disclosure relates to a sensor device for determining a position of a rotatably and/or longitudinally displaceably mounted structural component of a vehicle component for a motor vehicle, comprising at least one processing circuit which is set up to generate at least one electrical and rotational position-dependent sensor signal with a sensor signal voltage and to output it via at least one signal output.

### Description of the Related Art

Such a sensor device, which can also be referred to as a position sensor, is used to determine a current position of a structural component. The position can be understood to mean a rotational position or rotor position of the rotatably mounted structural component, for example. In addition or alternatively, the position can be understood to mean a longitudinal position or axial displacement of the longitudinally displaceably mounted structural component. Control signals are often generated on the basis of the current position, which are usually used to control the vehicle component that comprises the structural component.

For example, a rotational angle of the rotatably mounted structural component can be acquirable by way of the sensor device, wherein the corresponding item of angle information can represent an input quantity for controlling various quantities. One possible application example is the vehicle component provided as an electric machine, for example, in which a rotor forms the rotatably mounted structural component and the item of angle information is used in particular as an input quantity for controlling a torque and a speed of the electric machine. Another example with regard to the item of angle information relates to the vehicle component provided as a transmission device, in which a gear shaft or a gear wheel forms the rotatably mounted structural component.

In addition or alternatively, it can be provided that a current positioning or location of the structural component with regard to a longitudinal displacement is acquirable by way of the sensor device. In this case, the structural component is displaceable longitudinally or, in other words, linearly along a movement path, in particular a straight movement path. Possible application examples relate, for example, to cases in which a structural component, in particular a structural component with an elongated design, is mounted axially displaceably along its longitudinal direction. Specifically, this can relate, for example, to the vehicle component provided as the transmission device or as a clutch device.

Concepts for realizing a sensor-based determination of a rotational position of a rotatably mounted structural component of a vehicle component are known from DE 10 2010 038 770 A1, KR 10 2019 0 047 228 A and JP 2007-269 277 A.

### BRIEF SUMMARY

Embodiments of the present disclosure provide an improved concept in connection with the sensor-based determination of a position of a structural component of a vehicle component, in particular with regard to an error state relating to the respective sensor device.

According to the disclosure, a sensor device of the type mentioned at the outset and at least one processing circuit is further set up to check whether an error state relating to the sensor device is present in which the generation of the at least one sensor signal is prevented, and, in this case, to generate at least one error signal with an error signal voltage that deviates from the at least one sensor signal voltage and to output it via the at least one signal output.

The disclosure is based in particular on the idea that even in the case of an error state relating to the sensor device or the occurrence of an internal sensor error, the processing circuit actively causes a signal output so that the output error signal can be specifically identified as part of further signal processing. This identifiability is made possible by the fact that the sensor signal generated in a normal operation state and the error signal generated in the error state differ in terms of their respective signal voltages. These output signals are each present in the form of an electrical voltage, in particular an electrical voltage that is not zero, which is output via a signal output.

In particular, the present disclosure avoids the case in which, in the error state, a measurement voltage that depends on the output signal occurs at a control device connected to the sensor device and which would falsely indicate that the normal state is present and would arise due to circumstances within the control device. Such disadvantageous cases can occur, for example, if, in the event of an error, the sensor device does not output a specific error signal or specific output voltage via a signal output, but instead it is switched to a high-impedance state.

The processing circuit of the sensor device is preferably an application-specific integrated circuit or, in short, “ASIC” or, generally speaking, a so-called application-specific standard product or, in short, “ASSP.” It is conceivable that one or more processing circuits is or are provided, via which at least one output signal can be generated. Specifically, up to four signal outputs can be provided per processing circuit. Preferably, two processing circuits are provided per sensor device, each of the processing circuits preferably comprising four signal outputs.

The sensor device according to the disclosure preferably comprises at least one sensing circuit, by way of which at least one position-dependent measurement signal can be generated and output to the at least one processing circuit, wherein the at least one processing circuit is set up to generate the at least one sensor signal on the basis of the at least one measurement signal. The sensing circuit is understood to mean the part of the sensor device that implements a sensor. Thus, by way of the sensing circuit, the at least one measurement signal, in particular also provided as an electrical signal, can be generated, which can depend directly on the measurement quantity to be measured. The measurement quantity is or relates to the position. On the basis of the at least one measurement signal, the at least one sensor signal is generated by way of the processing circuit and which, in turn, relates to or describes the measurement quantity and thus also the position.

It is conceivable that the at least one sensing circuit forms an eddy current distance sensor. The functioning of an eddy current distance sensor is based on the fact that changes in a magnetic field in a solid, block-like measuring object made of an electrically conductive material cause eddy currents in the measuring object, wherein the magnetic fields created due to the eddy currents in turn counteract the cause of the eddy currents in accordance with Lenz's law. For example, the eddy current distance sensor comprises a transmitter and a receiver, wherein an alternating electromagnetic field is generated by the transmitter, which is received by the receiver. Depending on a distance between the arrangement, which comprises the transmitter and the receiver, and the measuring object, damping effects occur with regard to the alternating electromagnetic field, on the basis of which the measuring signals relating to the distance are determinable. It is also conceivable that the sensing circuit has an electromagnetic field coil at which an alternating voltage is applied, wherein the resulting alternating field in turn is impacted depending on the distance to the measuring object. Specifically, the impedance of the field coil changes depending on the distance, so that the measurement signals can be determined on the basis of this impedance change.

In order to enable the acquisition of the rotational position by way of the eddy current distance sensor, it is necessary that a relative distance between a surface of the measurement object, i.e., presently the rotatably mounted structural component or a component connected to it, and the eddy current distance sensor changes during rotation. For this purpose, an asymmetrical part can be arranged on the rotatably mounted structural component, which rotates together with the rotatably mounted structural component, so that the distance between the surface of the asymmetrical part and the eddy current distance sensor changes as a result. It is conceivable that the at least one sensing circuit is arranged on the front side of the rotatably mounted structural component or a shaft of the structural component, with a sensor or impeller wheel being arranged as the asymmetrical part on the front side of the structural component or the shaft. The sensor or impeller wheel can be a disk, on the front side of which an asymmetrical structure, for example comprising or forming vanes, is formed, which causes the distance that changes during rotation. The asymmetrical structural component consists of an electrically conductive material, such as a metal.

The at least one processing circuit can be set up to generate the at least one sensor signal in such a way that the sensor signal voltage of the at least one sensor signal changes periodically and within a normal operation voltage band, in particular sinusoidally, during a uniform rotation of the rotatably mounted structural component. It is conceivable that the current rotational position can be determined on the basis of the phase of the periodically changing signal, for example on the basis of a zero crossing of the sine or cosine wave. In addition, the current rotation speed can be determined on the basis of the period of the periodic sensor signal.

The at least one processing circuit can be set up to generate at least one error signal in such a way that the error signal voltage of the at least one error signal lies within at least one error operation voltage band, wherein the at least one error operation voltage band lies above or below the normal operation voltage band. It is conceivable that two error operation voltage bands are provided, wherein an upper error operation voltage band lies above the normal operation voltage band and a lower error operation voltage band lies below the normal operation voltage band.

According to this embodiment, the determination of the voltage of the respective output signal allows a distinction to be made as to whether this is the sensor signal or the error signal. The respective voltage band can also be referred to as a voltage interval. The voltage band can be continuous or gapless and in particular can range from a lower voltage value to an upper voltage value. There can be a gap between the voltage bands. This gap is preferably sufficiently wide to ensure that measured voltage values are not assigned to an incorrect voltage band due to measurement errors.

It is conceivable that the at least one processing circuit is set up to determine at least one item of error information relating to a type or a property of the error state and to output the at least one error signal in such a way that the error signal voltage of the at least one error signal depends on the at least one item of error information. According to this embodiment, the processing circuit not only acquires the mere presence of the error state, but also determines the item of error information specifically directed at the characteristics of the respective error present. The determination of the item of error information carried out by the processing circuit can be carried out by acquiring a circumstance that occurs specifically in the case of a certain error, for example relating to the type or characteristic of the measurement signals, with the error signal or its voltage depending thereon. This allows the presence of the respective error to be specifically taken into account in the context of the further processing of the error signal.

It is conceivable that the error signal voltage, depending on the item of error information, lies within an error operation voltage band specifically provided for the respective error present or a set of conceivable errors. Thus, as already mentioned above, several error operation voltage bands can be provided, wherein these error operation voltage bands in turn can each be assigned to at least one of the several items of error information. Thus, the at least one processing circuit can be set up to generate the respective error signal in the event of a specific item of error information in such a way that the error signal voltage of this error signal lies within one of several error operation voltage bands, namely the error operation voltage band assigned to the respective item of error information. It is also conceivable that several error signal voltages lie within a single error operation voltage band. In this case, a rough classification of the present voltage of the respective output signal can first be carried out as to whether it lies within the error operation voltage band or within the normal operation voltage band. Subsequently, a finer determination of the present voltage of the output signal can be carried out, namely, if the error signal is present, to which item of error information the current voltage is assignable or, if the sensor signal is present, to which position or rotational position the current voltage is assignable.

In addition, the disclosure relates to a control arrangement for controlling the operation of a vehicle component comprising a rotatably and/or longitudinally displaceably mounted structural component, comprising a sensor device according to the preceding description and a control device connected thereto in such a way that the signals generated by way of the sensor device are output to the control device. According to the disclosure, the control device is set up in this case to check on the basis of the respective signal voltage whether the signal generated in each case is the sensor signal or the error signal. The control device is further set up to generate control signals for controlling the operation of the vehicle component on the basis of the position of the structural component if the signal generated in each case is the sensor signal. In addition, the control device is set up to generate control signals for controlling the operation of the vehicle component taking into account that the error state is present and/or to generate control signals aimed at eliminating the error state if the signal generated in each case is the error signal. All advantages, features and aspects described in connection with the sensor device according to the disclosure are equally transferable to the control arrangement according to the disclosure, and vice versa.

It is conceivable that the control arrangement is set up to control the operation of an electric machine with the rotatably mounted structural component designed as a rotor. The control arrangement can also be set up to control the operation of a transmission device with the rotatably mounted structural component designed as a gear shaft or a gear wheel. It is also conceivable that the control arrangement is set up to control the operation of the vehicle component which has a structural component, in particular a structural component which is elongated and axially displaceably mounted along a longitudinal direction. In this case, the vehicle component can be the transmission device or a clutch device.

If the sensor signal is present, the control device is used to control the vehicle component as provided for normal operation. Otherwise, i.e., if the output signal is the error signal, the control device is used to control the vehicle component as provided for error operation, taking into account the presence of the error state. If several signal outputs are provided on the sensor device, via which several output signals are transmitted to the control device, then it can be provided that the output signals at the signal output at which the error state is currently present are not taken into account for determining the position, in particular the rotational position, with only the other output or sensor signals being used for this purpose. In addition or alternatively, the control signals generated by the control device can cause the error state to be immediately eliminated, for example if the error state is based exclusively on software-related circumstances and can be immediately eliminated by way of the control signals.

If, as previously described in connection with the sensor device according to the disclosure, the at least one processing circuit is set up to output the at least one error signal in such a way that the error signal voltage of the at least one error signal depends on the at least one item of error information, then it is preferably provided that the control device is set up to use the error signal voltage and taking into account the type of error state to generate the control signals for controlling the operation of the vehicle component and/or control signals aimed at eliminating the error state of the respective type. In this case, the item of error information determined by the sensor device is used by the control device to ensure that a measure specifically aimed at the respective error is carried out in the context of the generation of the control signals.

With regard to the control arrangement, it is conceivable according to the disclosure that the control device has at least one signal input via which the signals of the sensor device can be fed to an input circuit of the control device, wherein the signals of the sensor device or signals generated therefrom can be fed to at least one analog-digital converter connected in the input circuit, by way of which they are convertible into digital signals for further processing provided by the control device and/or a controller of the electric machine. As a result, between the at least one signal output of the sensor device and the at least one signal input of the control device, at least one electrical transmission means is therefore provided via which the output signals are transmittable. The transmission means can be an electrical conductor track of a circuit board or an electrical power cable.

The output signals or quantities or signals are converted into digital values by way of the analog-digital converter. Specifically, the signal voltage present or applied at the analog-digital converter is converted into numerical values, which describe this signal voltage. These numerical values can be stored in a continuously evolving data structure in which different values for the signal voltage can be assigned to different points in time. The data series created in this way can be used to evaluate the parameters of the sine or cosine shape of the sensor signal. With regard to further processing of the digital signals, it is conceivable that this processing is carried out by a control unit of the control device and/or a controller of the vehicle component.

As already described above, the output of the error signal provides advantages over the case in which the at least one signal output of the sensor device is switched to a high-impedance state in the event of an error. However, cases are conceivable in which the generation of the error signal is disadvantageous or not possible, for example if the sensor device is mechanically destroyed or the connection between the sensor device and the control device is severed. In this case, it is conceivable that, within the context of the present disclosure, the at least one signal output is switched or transferred to the high-impedance state in the event of such malfunction, or such a state is acquired by the control device. This is also conceivable if an error state or malfunction occurs for which no item of error information is present or determinable. In this case, too, the signal output can be actively switched to a high-impedance state. Consequently, according to the disclosure, it can be provided that the control arrangement is set up and/or designed so that the at least one signal output is placed in a high-impedance state in the event of a malfunction relating to the control arrangement. The input circuit is set up or designed such that in this case an electrical interference signal with an interference signal voltage is generated by way of the input circuit and fed to the analog-digital converter. It is conceivable that the interference signal voltage deviates from the voltage then applied at the analog-digital converter when the at least one sensor signal is generated by way of the sensor device. It is also conceivable that the interference signal voltage deviates from the voltage then applied at the analog-digital converter when the at least one error signal is generated by way of the sensor device. In this way, a distinguishing criterion as to whether the sensor signal or the error signal is present or whether the interference signal is present may be provided on the basis of the voltage value present.

It is also conceivable that the interference signal voltage lies in the range that is then applied at the analog-digital converter when the at least one sensor signal or the at least one error signal is generated by way of the sensor device. In this case, there may be a distinguishing criterion, for example, with regard to a temporal behavior or course of the respective signal. If this changes sinusoidally or cosinusoidally and is assigned to the normal operation voltage band, then it can be assumed that this is the sensor signal. If this remains almost constant and is assigned to the normal operation voltage band, then it can be assumed that this is the interference signal.

In the context of this embodiment, a refinement of the disclosure is preferably carried out in such a way that not only there is provided a distinguishability with regard to the sensor signal and the error signal, but that by way of the input circuit it is ensured that in the case in which the signal output is brought into the high-impedance state, a signal which is also distinguishable with regard to the sensor signal and the error signal, namely the interference signal, is applied at the analog-digital converter.

In the context of this embodiment, if the error signal is applied at the analog-digital converter, the control device is preferably set up to generate control signals for controlling the operation of the vehicle component taking into account that the malfunction is present and/or to generate control signals aimed at eliminating the malfunction.

With regard to the specific implementation of the control device or the input circuit, it is conceivable that the signal input or one of the signal inputs is connected to the analog-digital converter or to one of the analog-digital converters via an input line of the input circuit having an input resistor, wherein the control device further has a voltage component carrying an at least substantially constant supply voltage and/or a grounded grounding component or is connected to such, wherein at least one branch line leading to the voltage component or the grounding component and having a branch resistor is provided from the input line, in particular between the respective signal input and the input resistor. The supply voltage provided by way of the voltage component can be in the range up to 10 V. The supply voltage is preferably 5.0 V. The value of the input resistor and/or of the at least one branch resistor is, for example, several kilo-ohms.

It is conceivable that only the branch line leading to the voltage component is provided, but not the branch line leading to the grounding component. The branch resistor provided can have a value such that, in the case of the high-impedance state at the signal output, the signal or the interference signal voltage present at the analog-digital converter is in the range that is applied at the analog-digital converter when the error signal is generated by way of the sensor device. The branch resistor can have a resistance value such that in this case the interference voltage is assignable to the upper error operation voltage band, in which case the branch resistor can also be referred to as a pull-up resistor.

It is also conceivable that only the branch line leading to the grounding component is provided, but not the branch line leading to the voltage component. The branch resistor provided can have a value such that, in the case of the high-impedance state at the signal output, the signal applied at the analog-digital converter or the interference signal voltage is in the range that is applied at the analog-digital converter then when the error signal is generated by way of the sensor device. The branch resistor can have a resistance value such that in this case the interference voltage is assignable to the lower error operation voltage band and/or is 0 V, in which case the branch resistor can also be referred to as a pull-down resistor.

Finally, it is conceivable that both the branch line leading to the grounding component and the branch line leading to the voltage component are provided, in which case, in particular if the two branch resistors have comparable resistance values, the resulting circuit functions as a voltage divider, so that in this case the resulting interference signal voltage is assignable to the normal operation voltage band.

One conceivable problem relates to the occurrence of leakage currents, which can be caused by dirt or moisture, for example, and which could bridge components of the circuit. If this affects the branch resistor or at least one of the branch resistors and, as a result, a shunt bridging the respective branch resistor occurs, then this can cause a change in the signal applied at the analog-digital converter, so that errors can occur in this regard with regard to information which are determined on the basis of the voltages that occur in each case, such as identification of the normal operation state, the error state and/or the malfunction. In order to avoid this, it is conceivable that the interference signal voltage deviates sufficiently strongly from the voltage then applied at the analog-digital converter when the at least one sensor signal or the at least one error signal is generated by way of the sensor device, that such a deviation also exists when at least one shunt bridging the at least one branch resistor occurs.

Thus, when designing the input circuit or, generally speaking, the control arrangement, it can be provided that typical values can occur with regard to the at least one shunt, which is not a specific electrical component but is caused by dirt or moisture, with the values for the other resistances and voltages and the like being selected in such a way that even when there is a shunt, there is sufficient distinguishability between the malfunction and the normal operation state or the other states with the typical values. The typical values for any shunts are known from experience and can be in the kilo-ohm range or higher.

The present disclosure further relates to a vehicle component for a motor vehicle, comprising a rotatably and/or longitudinally displaceably mounted structural component and at least one sensor device according to the above description. The present disclosure further relates to a vehicle component for a motor vehicle, comprising a rotatably and/or longitudinally displaceably mounted structural component and at least one control arrangement according to the above description. All advantages, features and aspects explained in connection with the sensor device according to the disclosure and/or the control arrangement according to the disclosure are transferrable equally to the vehicle component according to the disclosure, and vice versa.

The vehicle component can be an electric machine with the rotatably mounted structural component designed as a rotor. The electric machine preferably comprises a housing, wherein a stator of the electric machine is stationarily mounted relative to the housing and the rotor is rotatably mounted relative to the housing. The control signals generated by way of the control device can be utilized in the context of the operation of the electric machine. For example, knowledge of the current rotor position of the rotor is typically required in the context of controlling the electric machine with regard to setting a current energization of windings of the electric machine.

The vehicle component can be a transmission device with the rotatably and/or longitudinally displaceably mounted structural component designed as a gear shaft or a gear wheel. In the context of controlling the operation of an actuator which forms part of the transmission device or is operatively connected to components of the transmission device, knowledge of the rotor position of the respective gear ratio of speeds that can be implemented by way of the transmission device is typically required. The same applies to the longitudinal position of the structural component.

The vehicle component can be a clutch device with the rotatably and/or longitudinally displaceably mounted structural component designed as a clutch disk or a clutch shaft. For example, the item of information as to whether the structural component is rotating and/or in which longitudinal position it is located can provide information as to whether the clutch is currently in an engaged or disengaged state.

The present disclosure also relates to a motor vehicle, comprising a vehicle component with a rotatably and/or longitudinally displaceably mounted structural component and at least one sensor device according to the above description or at least one control arrangement according to the preceding description. All advantages, features and aspects described in connection with the sensor device according to the disclosure and/or the control arrangement according to the disclosure and/or the vehicle component according to the disclosure can be equally transferred to the motor vehicle according to the disclosure, and vice versa.

Finally, the present disclosure relates to a method for operating a sensor device by way of which a position of a rotatably and/or longitudinally displaceably mounted structural component of a vehicle component for a motor vehicle is determined, wherein the sensor device comprises at least one processing circuit by way of which at least one electrical and position-dependent sensor signal with a sensor signal voltage is generated and output via at least one signal output. The object of the present disclosure is achieved in such a method according to the disclosure in that, by way of the at least one processing circuit, it is checked whether an error state relating to the sensor device is present in which the generation of the at least one sensor signal is prevented, wherein, in this case, at least one error signal with an error signal voltage that deviates from the at least one sensor signal voltage is generated by way of the at least one processing circuit and output via the at least one signal output. All in connection with the sensor device according to the disclosure and/or the control arrangement according to the disclosure and/or the vehicle component according to the disclosure and/or the motor vehicle according to the disclosure can be transferred equally to the method according to the disclosure, and vice versa.

### BRIEF DESCRIPTION OF THE SEVERAL VIEWS OF THE DRAWINGS

Further advantages and details of the present disclosure are apparent from the exemplary embodiments set forth below and from the figures. In these figures, schematically:

FIG. 1 shows a block diagram of a motor vehicle according to the disclosure according to an exemplary embodiment, comprising a vehicle component according to the disclosure according to an exemplary embodiment designed as an electric machine, and a control arrangement according to the disclosure according to an exemplary embodiment with a sensor device according to the disclosure according to an exemplary embodiment,

FIG. 2 shows a front view of a sensor or impeller wheel arranged on a rotor of the electric machine of FIG. 1,

FIG. 3 shows a circuit diagram relating to the control arrangement of the motor vehicle of FIG. 1, and

FIG. 4 shows a coordinate system relating to the temporal course and the voltage levels of sensor and error signals generated by the sensor device of the motor vehicle of FIG. 1.

### DETAILED DESCRIPTION

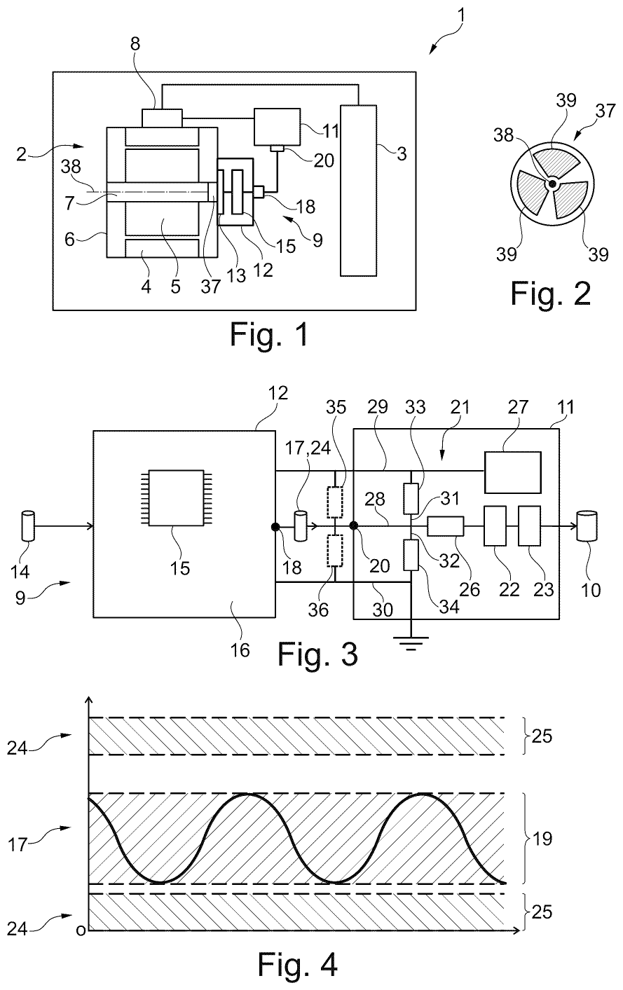

FIG. 1 shows a schematic block diagram of a motor vehicle 1 according to the disclosure according to an exemplary embodiment, which is an electric vehicle in the present case. Motor vehicle 1 comprises a vehicle component 2 according to the disclosure according to an exemplary embodiment, which is an electric machine that implements a traction motor, by way of which electrical energy stored in an electrical energy storage device 3 of motor vehicle 1 is convertible into kinetic energy of motor vehicle 1, and vice versa. In principle, the principles set forth below are equally conceivable for any vehicle component 2 that has a structural component 5 that is rotatably mounted relative to a stationary section of vehicle component 2, as is the case with a transmission device, for example.

Specifically and by way of example, it is provided in the present case that vehicle component 2 is the electric machine, which has a stator 4 and rotatably mounted structural component 5 designed as a rotor, wherein stator 4 is mounted in a rotationally fixed manner with respect to a housing 6 of the electric machine or vehicle component 2, and the rotor or structural component 5 together with a shaft 7 of structural component 5 is rotatably mounted. In order to convert the electrical energy into kinetic energy and vice versa, magnetic fields and electrical currents interact with one another, which are generated by windings and optionally by permanent magnets of stator 4 and the rotor or structural component 5, or which are present.

For this purpose, the electric machine or vehicle component 2 comprises power electronics 8, by way of which a direct current voltage present on the part of electrical energy storage device 3 is convertible into an alternating current voltage present on the part of the electric machine or vehicle component 2, and vice versa. The control required for this purpose is sometimes carried out using control signals 10 generated by a control arrangement 9 according to the disclosure (see FIG. 3), which are transmitted from control arrangement 9 to power electronics 8. A current position or, more precisely, rotational position of the rotor or structural component 5 provides a control basis required for this purpose, since the energization of the windings present on the part of the electric machine or vehicle component 2 takes place depending on the current rotational position.

In order to determine the current position or rotational position of the rotor or structural component 5, from which other quantities such as its rotational speed and the like can sometimes be determined, control arrangement 9 comprises, in addition to a control device 11, a sensor device 12 according to the disclosure according to an exemplary embodiment. The functioning of control arrangement 9 according to the disclosure is explained below with reference to FIG. 3, which shows a circuit diagram of control arrangement 9. By way of the information set forth below, a method according to the disclosure according to an exemplary embodiment is also explained, which is carried out in motor vehicle 1 or control arrangement 9.

Sensor device 12 comprises at least one sensing circuit 13, each of which implements an eddy current distance sensor. Sensing circuit 13 is arranged on the front side of shaft 7 and is stationary with respect to housing 6. On the front side of shaft 7, in turn, a sensor or impeller 37 made of a metal is arranged, which can also be thought of as a component of sensing circuit 13 and rotates together with the rotor or structural component 5 during the rotation thereof.

To better understand how sensing circuit 13 works, FIG. 2 shows a front view of sensor or impeller wheel 37, with an axis of rotation 38, about which the rotor or structural component 5 rotates, being perpendicular to the drawing plane in FIG. 2. Sensor or impeller wheel 37 has raised sections or vanes 39, which are indicated in FIG. 2 by way of the hatching. When structural component 5 rotates, vanes 39 also rotate. Sensing circuit 13 comprises a transmitter and a receiver, which are etched onto a circuit board 16 of a processing circuit 15, for example. The transmitter generates an alternating electromagnetic field, which is received by the receiver. The alternating field causes eddy currents in sensor or impeller wheel 37, which in turn attenuate the alternating field. This effect, which depends on the distance between the transmitter or receiver and sensor or impeller 37, is determinable on the basis of the magnitude of the alternating field received by the receiver. Furthermore, the magnitude of this effect changes on the basis of the rotation of structural component 5 and thus sensor or impeller wheel 37, since the eddy currents mainly occur in the area of vanes 39. The strongest attenuation effect occurs when one of vanes 39 is arranged in the middle or centrally in the system comprising the transmitter and the receiver. The weakest attenuation effect occurs when a gap between vanes 39 is arranged in the middle or centrally in the system comprising the transmitter and the receiver. Between these extreme states, the magnitude of the alternating field received by the receiver changes periodically, in particular sinusoidally, with the values received by the receiver being processed as measurement signals 14 by way of processing circuit 15. When viewed over time, the measurement signals have the form of two superimposed sine functions or a beat, wherein a short period of this form corresponds to the period of the alternating field, wherein a long period of this form, which also forms corresponding envelope curves, is created by way of the rotation of sensor or impeller wheel 37.

Processing circuit 15 is set up and designed to generate sensor signals 17 that depend on measurement signals 14 generated by sensing circuit 13 and thus describe the current rotational position of the rotor or structural component 5. Sensor signals 17 are output to control device 11 via a signal output 18 of sensor device 12. Sensor signals 17 output as electrical voltage values relate to the magnitude of the alternating field received by the receiver and are therefore present in the form of a corresponding sinusoidal oscillation that has the periodicity of the envelope curves mentioned above.

In total, there is a four-fold output of sensor signals 17, namely via four different signal outputs 18 of sensor device 12, which are each connected to processing circuit 15. The information content output via four signal outputs 18 regarding the position or rotational position of structural component 5 is redundant, but necessary for safety reasons, such as those that must be present in accordance with a predetermined ASIL classification (ASIL is an abbreviation for “Automotive Safety Integrity Level”). With regard to first signal output 18, sensor signals 17 are output as a sine signal. With regard to second signal output 18, sensor signals 17 are output as a correspondingly negated sine signal and thus forms a second of total envelope curves present. With regard to third signal output 18, sensor signals 17 are output as a cosine signal. With regard to fourth signal output 18, sensor signals 17 are output as a correspondingly negated cosine signal. Processing circuit 15 is therefore set up to generate these four signal outputs as redundant information carriers on the basis of measurement signals 14.

The components just explained, i.e., sensing circuit 13 with the transmitter and the receiver, processing circuit 15 assigned to sensing unit 13, and four signal outputs 18, are each provided in duplicate, for example. Accordingly, the acquisition of measurement signals 14 and the resulting generation of sensor signals 17 are also carried out in duplicate for safety reasons. In total, sensor device 12 therefore has eight signal outputs 18, each of which provides measurement signals 14 independently of one another. For reasons of clarity, only one of the eight signal outputs 18 and one of the two processing circuits 15 are shown in FIG. 3. The same applies to the eight components assigned to this signal output 18 by control device 11.

With regard to processing circuits 15, it is provided that they each form a so-called application-specific integrated circuit or, in short, “ASIC.” Alternatively, processing circuits 15 can each form a so-called application-specific standard product or, in short, “ASSP.” Processing circuits 15, like sensing circuits 13, are carried by circuit board 16 or are arranged thereon, which in turn is located on the front side of shaft 7.

Although, for the sake of simplicity, reference is made below to only a single sensor signal 17 or one of the eight signal outputs, corresponding sensor signals 17 are output for each of signal outputs 18 by way of sensor device 12. Thus, specific details regarding sensor signal 17 are explained below, in particular with reference to FIG. 4. FIG. 4 shows a coordinate system whose abscissa relates to time and whose ordinate relates to the voltage value present at signal output 18, i.e., sensor signal 17. The case shown here is one in which the rotor or structural component 5 rotates evenly or uniformly, i.e., at a constant angular velocity. In this case, processing circuit 15 generates sensor signal 17 in such a way that the associated sensor signal voltage changes periodically, namely in this case sinusoidally. One period of this cyclical change corresponds to the revolution time for a complete rotation of the rotor. The sensor signal voltage is understood to mean the value for the electrical voltage present at signal output 18 during the generation of sensor signals 17. Here, the sensor signal voltage is always within a normal operation voltage band 19, which is indicated in FIG. 4 by way of a hatched line and can also be referred to as a normal operation voltage interval. The normal operation voltage band here comprises, by way of example, the range between a lower voltage value of 0.5 V and an upper voltage value of 4.0 V.

Sensor device 12 and control device 11 are connected to one another in such a way that sensor signals 17 output via signal output 18 reach an analog-digital converter 22 of control device 11 via a signal input 20 and an input circuit 21 of control device 11, which analog-digital converter 22 in turn converts the voltage values applied at the analog-digital converter 22 into digital signals and outputs them to a control unit 23 of control device 11, which in turn generates the control signals 10 on the basis of sensor signals 17 converted into digital signals and outputs them to power electronics 8 or a controller assigned to power electronics 8 and not shown in detail in the figures.

The aspects explained so far regarding the generation of control signals 10 relate to a normal operation state of sensor device 12 or control arrangement 9, in which the generation of sensor signals 17 on the basis of measurement signals 14 is possible as intended and therefore without limitation. The case in which an error state is present is explained below, in which the generation of sensor signals 17 is prevented or is not possible as intended and without errors. Processing circuit 15 is set up and designed to check whether such an error state, i.e., an internal sensor error, is present. In this case, instead of sensor signal 17, an error signal 24 is output to control device 11 via signal output 18 by way of processing circuit 15. Generated error signal 24 differs from sensor signals 17 in that an error signal voltage of error signal 24 deviates or differs from the sensor signal voltage. The error signal voltage is understood to mean the value for the electrical voltage present at signal output 18 during the generation of error signal 24.

In this regard, processing circuit 15 is set up to generate error signal 24 in such a way that the error signal voltage lies within an error operation voltage band 25. Specifically and by way of example, two error operation voltage bands 25 are provided here, which are marked in FIG. 4 by way of hatching. It is provided here that the error operation voltage bands 25 deviate from the normal operation voltage band 19 in a disjoint manner, i.e., no voltage values exist that can be assigned to both types of bands 19, 25. Preferably, there are distances between the bands 19, 25. In the present exemplary embodiment, it is provided that an upper error operation voltage band 25 is located above normal operation voltage band 19 and at a distance from it, and a lower error operation voltage band 25 is located below normal operation voltage band 19 and at a distance from it.

A further aspect relating to the error state is the fact that an item of error information relating to a type or property of the error state currently present is determined by way of processing circuit 15. Respective error signal 24 is generated and output on the basis of the item of error information in such a way that the error signal voltage of error signal 24 generated in each case depends on the item of error information and thus on the type or property of the current error state. For example, processing circuit 15 is set up to recognize a short circuit as an error state and to assign it to a related item of error information, and in this case to set the error signal voltage to a value specifically specified for this item of error information, for example in one of the upper or lower of the two error operation voltage bands 25. Consequently, error signals 24 with different error signal voltages are output for different error states. With regard to the short circuit, several cases can be provided for or distinguished with regard to the generation or acquisition of the item of error information, namely a short circuit between one of the eight lines connecting one of the signal outputs to one of signal inputs 20 with a line carrying a supply voltage, with a grounded line or with another of the eight lines connecting one of the signal outputs to one of the signal inputs 20. Furthermore, with regard to the items of error information, it is conceivable that they are determined as part of an error or self-diagnosis carried out internally by processing circuit 15, for example if it is determined by sensors that a temperature limit value is exceeded in one of the components of processing circuit 15.

Analogous to sensor signal 17, error signal 24 is then fed to analog-digital converter 22, which also converts error signal 24 into a digital signal and feeds it to control unit 23. Control device 11 or control unit 23 is set up to check on the basis of the present signal voltage whether the respective present signal 17, 24 is sensor signal 17 or error signal 24.

In the first case, in which sensor signal 17 and thus the normal operation state is present, control signals 10 for controlling the operation of the electric machine or vehicle component 2 are generated and output as explained above. In the second case, in which error signal 24 and thus the error state is present, control device 11 also generates and outputs control signals 10 for controlling the operation of the electric machine or vehicle component 2, but the fact that error signal 24 is present at the respective signal output 18 is taken into account. With regard to determining the rotational position of the rotor or structural component 5, in this case only the signals or sensor signals 17 output via other signal outputs 18 not affected by the error state are taken into account. Furthermore, in this case control signals 10 are generated which are aimed at eliminating the error state. Specifically, these control signals 10 cause an output, for example, output via an output device of motor vehicle 1 not shown in detail, which informs the driver about the presence of the error state and, if necessary, prompts said driver to visit a workshop.

Furthermore, control device 11 or control unit 23 is set up to generate control signals 10 specifically for the respective error state on the basis of the present error signal voltage, which in turn depends on the item of error information. For example, the user output can also comprise information regarding the type or property of the error state. If this is possible, control signals 10 generated by control unit 23 cause the error state to be immediately eliminated, for example if it is based exclusively on software-related circumstances and can be immediately eliminated by way of control signals 10.

The following describes the case in which there is a malfunction with respect to control arrangement 9, which differs from the error state already mentioned in that no item of error information is present in the context of the malfunction and therefore no specific error signal voltage can be specified by sensor device 12. An example in this regard is damage or mechanical destruction of at least one of the components of sensor device 12.

In this case, control arrangement 9 is set up or designed to put signal output 18 into a high-impedance state. This means that an ohmic resistance present at signal output 18 becomes so high that this case ultimately corresponds to severing the line connecting signal output 18 and signal input 20. In this case, an interference signal is generated at analog-digital converter 22, which depends exclusively on circumstances on the part of control device 11, but not on sensor device 12. In this case, it is conceivable that input circuit 21 causes the interference signal or the interference signal voltage to deviate from all conceivable values for the voltages applied at analog-digital converter 22 that would otherwise be applied at analog-digital converter 22, i.e., when sensor signal 17 or error signal 24 is present. Control device 11 or control unit 23 is set up to generate control signals 10 when the interference signal is present, taking into account that there is a malfunction, and to output them to the electric machine or vehicle component 2 and also to generate control signals 10 aimed at eliminating the malfunction, which cause a corresponding output via the output device, for example.

Details of input circuit 21 are explained below with reference to FIG. 3 by way of example. Signal input 20 is connected to analog-digital converter 22. A high-impedance input resistor 26, or one in the kilo-ohm range, is connected to input line 28 provided for this purpose. Furthermore, a voltage component 29 is provided which is connected to a voltage source 27 and carries the supply voltage and is designed as a line. The supply voltage in this case is 5.0 volts, for example. Furthermore, a grounded grounding component 30 is provided, which is also designed as a line. Two branch lines 31, 32 branch off from input line 28 between signal input 20 and input resistor 26. A first branch line 31 leads to voltage component 29 via a first branch resistor 33, which is also referred to as a pull-up resistor. A second branch line 32 leads to the grounding component 30 via a second branch resistor 34, which is also referred to as a pull-down resistor. Branch resistors 33, 34 are, like input resistor 26, high-resistance and are thus in the kilo-ohm range.

It is clear that the interference signal voltage applied at analog-digital converter 22 depends exclusively on the values of the supply voltage and resistors 26, 33, 34 in the case in which signal output 18 is set to the high-impedance state. With reference to FIG. 4, this value is, for example, in a range that cannot be assigned to any of bands 19, 25. Specifically, the interference signal voltage deviates so strongly from the values applied at analog-digital converter 22 when sensor signal 17 or error signal 24 is present that even if there is at least one shunt 35, 36, control device 11 or control unit 23 can sufficiently distinguish between the interference signal and signals 17, 24.

With reference to the circuit shown in FIG. 3, a first shunt 35 is conceivable, which bridges first branch resistor 33. In addition or alternatively, a second shunt 36 is conceivable, which bridges second branch resistor 34. Shunts 35, 36 indicated by dashed lines in FIG. 3, which are not actual electronic structural components provided but can be present due to contamination or moisture, essentially cause a parallel circuit comprising one of shunts 35, 36 and respective associated branch resistor 33, 34. This obviously leads to the interference signal voltage actually present at analog-digital converter 22 deviating from the ideal case in which shunts 35, 36 would not be present. However, in the present case, the values for the supply voltage and for resistors 26, 33, 34 are selected such that a deviation with respect to the interference signal voltage resulting from typically occurring values for shunts 35, 36 is sufficiently small so that a distinction can be made between normal operation, error operation and malfunction.

Contrary to the above, it is also conceivable that the interference signal voltage is in the range that is applied at analog-digital converter 22 when sensor signal 17 or error signal 24 is generated by way of sensor device 12. In this case, it is conceivable to distinguish between these cases via the temporal characteristics of the respective signal. If this signal changes sinusoidally or cosinusoidally and is assigned to normal operation voltage band 19, then it can be assumed that this is sensor signal 17. If this signal remains almost constant and is assigned to normal operation voltage band 19, then it can be assumed that it is the interference signal. Input circuit 21 shown in FIG. 3, comprising two branch resistors 33, 34, which have comparable resistance values, functions as a voltage divider, so that the resulting interference signal voltage can be assigned to the normal operation voltage band.

With reference to FIG. 3, it is also conceivable that no distinction is provided for between the presence of error signal 24 and the interference signal. For example, according to a first case, it is conceivable that only first branch line 31 together with first branch resistor 33 is provided, but not second branch line 32 together with second branch resistor 34. First branch resistor 33 has a value such that, in the case of the high-impedance state at signal output 18, the signal or interference signal voltage applied at analog-digital converter 22 is in the range that can be assigned to the upper error operation voltage band 25, in which case the branch resistor can also be referred to as a pull-up resistor.

According to a second case, it is conceivable that only second branch line 32 together with second branch resistor 34 is provided, but not first branch line 31 together with first branch resistor 33. Second branch resistor 34 has a value such that, in the case of the high-impedance state at signal output 18, the signal or the interference signal voltage applied at analog-digital converter 22 is in the range that can be assigned to the lower error operating voltage band 25 or is 0 V, in which case the branch resistor can also be referred to as a pull-down resistor.

In addition, it should be noted that motor vehicle 1 comprises further vehicle components 2 according to the disclosure, which work analogously with regard to the transmission of signals 17, 24 just described and are therefore not shown separately in the figures for the sake of clarity. In contrast to vehicle component 2 provided as the electric machine, in the case of further vehicle components 2 it is provided to provide for a longitudinally displaceable structural component 5 instead of the rotatably mounted structural component 5 or that rotatably mounted structural component 5 is also mounted longitudinally displaceably. This applies, for example, to the transmission device already mentioned above. Furthermore, a clutch device is provided as one of further vehicle components 2. Longitudinally displaceable structural component 5 is a longitudinally displaceable shaft in both the transmission device and the clutch device, on each of which a further sensor device 12 according to the disclosure is arranged. Instead of or in addition to the current rotational position of the structural component 5, the current longitudinal position or, in other words, axial displacement is determined in addition or alternatively as the position of the transmission device and the clutch device.

German patent application no. 102024109336.6, filed Apr. 3, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A sensor device for determining a position of a rotatably and/or longitudinally displaceably mounted structural component of a vehicle component for a motor vehicle, the sensor device comprising:
at least one processing circuit that, in operation, generates at least one sensor signal with a sensor signal voltage and outputs the at least one sensor signal via at least one signal output,
wherein the at least one sensor signal is electrical and position-dependent, and
wherein the at least one processing circuit, in operation, checks whether an error state relating to the sensor device is present in which generation of the at least one sensor signal is prevented, and, if the error state relating to the sensor device is present, generates at least one error signal with an error signal voltage that deviates from the sensor signal voltage and outputs the at least one error signal via the at least one signal output.

2. The sensor device according to claim 1, further comprising:
at least one sensing circuit that, in operation generates at least one measurement signal based on the position and outputs the at least one measurement signal to the at least one processing circuit, wherein the at least one processing circuit, in operation, generates the at least one sensor signal based on the at least one measurement signal.

3. The sensor device according to claim 2, wherein the at least one sensing circuit forms an eddy current distance sensor.

4. The sensor device according to claim 1, wherein the at least one processing circuit, in operation, generates the at least one sensor signal such that the sensor signal voltage of the at least one sensor signal changes periodically and within a normal operation voltage band during a uniform rotation of the rotatably and/or longitudinally displaceably mounted structural component.

5. The sensor device according to claim 4, wherein the at least one processing circuit, in operation, generates the at least one error signal such that the error signal voltage of the at least one error signal lies within at least one error operation voltage band, wherein the at least one error operation voltage band lies above or below the normal operation voltage band.

6. The sensor device according to claim 1, wherein the at least one processing circuit, in operation, determines at least one item of error information relating to a type or a property of the error state and outputs the at least one error signal such that the error signal voltage of the at least one error signal depends on the at least one item of error information.

7. A control arrangement for controlling operation of a vehicle component, the control arrangement comprising:
a rotatably and/or longitudinally displaceably mounted structural component, the rotatably and/or longitudinally displaceably mounted structural component including:
a sensor device according to claim 1; and
a control device connected to the sensor device such that signals generated by way of the sensor device are output to the control device, wherein the control device, in operation:
checks, based on respective signal voltages of the signals, whether each of the signals is the sensor signal or the error signal;
if at least one of the signals is the sensor signal, generates control signals that control the operation of the vehicle component based on the position of the rotatably and/or longitudinally displaceably mounted structural component; and
if at least one of the signals is the error signal, generates control signals that control the operation of the rotatably and/or longitudinally displaceably mounted structural component, taking into account that the error state is present, and/or generates control signals that eliminate the error state.

8. The control arrangement according to claim 7, wherein the at least one processing circuit, in operation, determines at least one item of error information relating to a type or a property of the error state,
wherein the at least one processing circuit, in operation, outputs the at least one error signal such that the error signal voltage of the at least one error signal depends on the at least one item of error information, and
wherein the control device, in operation, generates the control signals that control the operation of the vehicle component and/or control signals that eliminate the error state of the type based on the error signal voltage and taking into account the type of error state.

9. The control arrangement according to claim 7, wherein the control device has at least one signal input via which the signals of the sensor device are fed to an input circuit of the control device, and wherein the signals of the sensor device or signals generated therefrom are fed to at least one analog-digital converter connected in the input circuit, by way of which the signals of the sensor device or signals generated therefrom are convertible into digital signals for further processing.

10. The control arrangement according to claim 9, wherein the control arrangement, in operation, puts the at least one signal output into a high-impedance state in response to a malfunction relating to the control arrangement, and when the at least one signal output is put into the high-impedance state, generates an electrical interference signal with an interference signal voltage by way of the input circuit and feeds the electrical interference signal to the analog-digital converter, wherein the control device, in operation, if the interference signal is applied at the analog-digital converter, generates control signals that control the operation of the vehicle component taking into account that the malfunction is present and/or to generates control signals that at least partially eliminate the malfunction.

11. The control arrangement according to claim 9, wherein the signal input or one of the signal inputs is connected to the analog-digital converter or to one of the analog-digital converters via an input line of the input circuit having an input resistor, wherein the control device further has or is connected to a voltage component carrying an at least substantially constant supply voltage and/or a grounded grounding component, wherein at least one branch line leading to the voltage component or the grounding component and having a branch resistor is provided from the input line between at least one of the signal inputs and the input resistor.

12. A vehicle component for a motor vehicle, the vehicle component comprising:
a rotatably and/or longitudinally displaceably mounted structural component; and
the sensor device according to claim 1.

13. The vehicle component according to claim 12, wherein the vehicle component is:
an electric machine with the rotatably and/or longitudinally displaceably mounted structural component as a rotor, or
a transmission device with the rotatably and/or longitudinally displaceably mounted structural component as a gear shaft or a gear wheel, or
a clutch device with the rotatably and/or longitudinally displaceably mounted structural component as a clutch disk or a clutch shaft.

14. A motor vehicle, comprising:
a vehicle component with a rotatably and/or longitudinally displaceably mounted structural component; and
the sensor device according to claim 1.

15. A method for operating a sensor device by way of which a position of a rotatably and/or longitudinally displaceably mounted structural component of a vehicle component for a motor vehicle is determined, wherein the sensor device includes at least one processing circuit by way of which at least one sensor signal with a sensor signal voltage is generated and output via at least one signal output, and wherein the at least one sensor signal is electrical and position-dependent, the method comprising:
checking, by way of the at least one processing circuit, whether an error state relating to the sensor device is present in which the generation of the at least one sensor signal is prevented; and
in response to determining that the error state relating to the sensor device is present, generating, by way of the at least one processing, at least one error signal with an error signal voltage that deviates from the sensor signal voltage and outputting the at least one error signal via the at least one signal output.
